(19) United States
(12) Patent Application Publication
(10) Pub. No.: US 2018/0374111 A1
(43) Pub. Date: Dec. 27, 2018

(54) SYSTEMS AND METHODS FOR RESTRICTING MOBILE DEVICE USE

(71) Applicant: Safe2Save, LLC, College Station, TX (US)

(72) Inventor: Marci Corry, College Station, TX (US)

(21) Appl. No.: 15/990,594

(22) Filed: May 26, 2018

Related U.S. Application Data
(60) Provisional application No. 62/511,787, filed on May 26, 2017.

(51) Int. Cl. G06Q 30/02; B60W 40/09; G06Q 50/30

(52) U.S. Cl. CPC G06Q 30/0207; B60W 40/09; B60W 2520/10; B60W 2540/30; G06Q 50/30

(57) ABSTRACT

Systems and methods for reinforcing and rewarding safe driving practices are described. In some embodiments, systems and methods may determine when a user is traveling at a speed or above a threshold speed, and when the user has also refrained from usage of a mobile communication device or use of certain or attempting to use certain features of the device, such as text messaging, voice calls email communication, or navigational aids. The user may then be credited with points which may be used in a reward points system serving as a reinforcement tool to promote safer motor vehicle operation.

### PRIORITY CLAIM

This application claims priority to U.S. Provisional Patent Application No. 62/511,787, titled “System and Method for Restricting Mobile Device Use” filed May 26, 2017, the disclosure of which is herein fully incorporated by reference.

### COPYRIGHT NOTICE

This application contains material that is subject to copyright protection. Such material may be reproduced exactly as it appears in Patent and Trademark Office patent files or records. The copyright owner otherwise reserves all rights to such material.

### BACKGROUND

Driver distraction is one of the leading causes of traffic accidents. For example, driver distraction due to texting, browsing, or other cellphone use may account for as much as a quarter of all traffic accidents in the United States. Attempts have been made to limit cellphone use or to promote safe driving habits. However, efforts to promote safe driving habits have not been highly successful.

Accordingly, there is a need for improved systems for promoting safe driving habits. Particularly, there is a need for incentive-based rewards systems, including those that allow participating sponsors to provide rewards. There is still further a need for systems designed to block selected functions of a cellphone or provide warning messages to a user if the user engages the selected functions while driving, but allowing access to other functions, including, for example, those other functions that may be safely executed while driving.

### BRIEF DESCRIPTION OF THE DRAWINGS

FIG. 1 is a diagram of an embodiment of a system for promoting safe driving habits.

FIG. 2 is a diagram of another embodiment of a system for promoting safe driving habits.

FIG. 3 is a diagram of still another embodiment of a system for promoting safe driving habits.

FIG. 4 is an embodiment of a flowchart of a method for administering a rewards redemption program for encouraging safe driving habits.

FIG. 5 is an embodiment of a flowchart of a method for encouraging safe driving habits in a user.

FIG. 6 is an embodiment of a screenshot showing an introduction screen displayed on a mobile device using an embodiment of an installed mobile device application.

FIG. 7 is an embodiment of a screenshot showing a registration of new user screen displayed on a mobile device using an embodiment of an installed mobile device application.

FIG. 8 is an embodiment of a screenshot showing a login page displayed on a mobile device using an embodiment of an installed mobile device application.

FIG. 9 is an embodiment of a screenshot showing a picture upload screen displayed on a mobile device using an embodiment of an installed mobile device application.

FIG. 10 is an embodiment of a screenshot showing a picture uploaded picture displayed on a locked mobile device using an embodiment of an installed mobile device application.

FIG. 11 is an embodiment of a screenshot showing an avatar creation screen displayed on a mobile device using an embodiment of an installed mobile device application.

FIG. 12 is an embodiment of a screenshot showing a configurations screen displayed on a mobile device using an embodiment of an installed mobile device application.

FIG. 13 is an embodiment of a screenshot showing an alert screen displayed on a mobile device using an embodiment of an installed mobile device application.

FIG. 14 is an embodiment of a screenshot showing an accumulated points screen displayed on a mobile device using an embodiment of an installed mobile device application.

FIG. 15 is an embodiment of a screenshot showing a reward display screen displayed on a mobile device using an embodiment of an installed mobile device application.

FIG. 16 is an embodiment of a screenshot showing an additional reward screen displayed on a mobile device using an embodiment of an installed mobile device application.

FIG. 17 is an embodiment of a screenshot showing another rewards screen displayed on a mobile device using an embodiment of an installed mobile device application.

FIG. 18 is an embodiment of a screenshot showing a confirmation of a rewards expenditure screen displayed on a mobile device using an embodiment of an installed mobile device application.

FIG. 19 is an embodiment of a screenshot showing a rewards instruction screen displayed on a mobile device using an embodiment of an installed mobile device application.

FIG. 20 is an embodiment of a screenshot showing an in-application map screen displayed on a mobile device using an embodiment of an installed mobile device application.

FIG. 20 A is an embodiment of a screenshot showing how to access the in-application map screen displayed in FIG. 20.

FIG. 21 is an embodiment of a screenshot showing a terms of use screen displayed on a mobile device using an embodiment of an installed mobile device application.

FIG. 22 is an embodiment of a screenshot showing a message appearing when exiting a text message function.

FIG. 23 is an embodiment of a screenshot showing functions that may be used when operating an application.

FIG. 23 is an embodiment of a screenshot showing a leaderboard displayed on a mobile device using an embodiment of an installed mobile device application.

FIG. 25 is an embodiment of a method for encouraging safe driving habits.

### SUMMARY

In some embodiments, a system for reinforcing and rewarding safe driving practices may be configured to determine when a user is traveling at a speed or above a threshold speed, and when the user has also refrained from usage of a mobile communication device or use of certain or attempting to use certain features of the device, such as text messaging, voice calls email communication, or navigational aids. The user may then be credited with points which may be used in a reward points system serving as a reinforcement tool to promote safer motor vehicle operation.

### DETAILED DESCRIPTION

The following terms as used herein should be understood to have the indicated meanings.

When an item is introduced by “a” or “an,” it should be understood to mean one or more of that item.

The term “acceleration” as used herein means a change in velocity over time or speed over time. Acceleration may refer to an increase or a decrease in velocity or speed over time. Thus, the term acceleration may encompass a deceleration. However, sometimes in this disclosure, where a speed or velocity is specifically decreasing over time, the more specific term deceleration may also be used.

“Comprises” means includes but is not limited to.

“Comprising” means including but not limited to.

The term “vehicle condition data” includes data that may indicate that a vehicle is in a certain state, such as moving or not moving. Vehicle condition data may originate form one or more sensors manufactured as part of a vehicle itself. Vehicle condition data may also originate from one or more other sensor devices which may be disposed in proximity or attached to a vehicle, such as a cellphone, onboard hardware device, or plug-in sensor device, for example. By way of nonlimiting example, vehicle condition data consistent with vehicle motion may include data indicating a speed or velocity, data indicating a threshold speed or velocity, data indicating a change in position consistent with a vehicle trip, or other data, and any combinations thereof. In some embodiments, a device configured for producing vehicle condition data may be specifically verified to be attached or located in proximity to a vehicle, such as by transmission of one or more exchange pulses between the device and a vehicle or other device known to be attached or connected to the vehicle. In some embodiments, a device configured for producing vehicle condition data may be specifically verified to be located on a specific side of a vehicle, such as on the driver or the front passenger side of a vehicle. Thus, for example, where the device is a mobile communications device, some systems herein may be configured to determine if the communications device is being used by a driver or a passenger.

Where a range of values is described, it should be understood that intervening values, unless the context clearly dictates otherwise, between the upper and lower limits of that range, and any other stated or intervening value in other stated ranges, may be used within embodiments described herein.

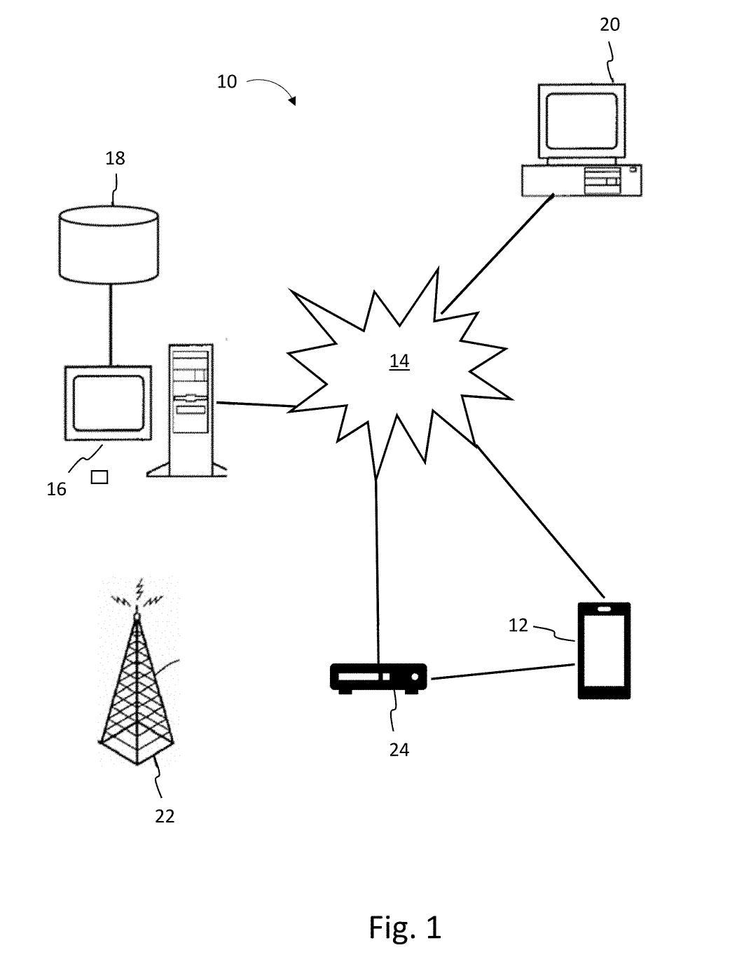

In some embodiments, a system 10 may be configured to provide a service for reinforcing and rewarding safe driving practices implemented over a distributed network 14, which may be wired or wireless, such as shown in FIG. 1. The system 10 may comprise a server 16 in communication with a database 18. The service may, for example, provide data and services to one or more users through an application installed on a location-aware computer or mobile communications device 12 of the user. In some embodiments, mobile device 12 with an installed application may be configured for collection and processing of one or more sensor signals to determine one or more conditions of a vehicle during motion, logging use or attempted use of one or more device functions, providing selective access to one or more device functions, and correlation of vehicle condition data to device function use or attempted use. The mobile device 12 may further be configured via an installed application to perform one or more functions associated with rewards points accumulation, use of rewards, and/or other functions as further described herein.

In some embodiments, system 10 may also include one or more onboard hardware devices 24, such as may be attached or placed within a vehicle. For example, an onboard hardware device 24 may be a device that may be connected to a vehicle via an auxiliary power socket such as a cigarette lighter socket. In some embodiments, an onboard hardware device 24 may be configured to access a vehicle on-board diagnostics system (OBD) and to collect vehicle condition data therefrom. In some embodiments, onboard hardware device 24 may comprise a portable telematics unit, which may include telematics capabilities and may be configured to communicate with one or more remote entities. For example, a portable telematics unit may have one or more capabilities to manually or automatically contact one or more emergency providers if a vehicle condition indicative of an emergency condition is detected. In some embodiments, onboard hardware device 24 may be configured for collection, processing, or both of one or more sensor signals to determine one or more conditions of a vehicle during motion. In some embodiments, onboard hardware device 24 may further be in communication with mobile device 12. For example, onboard hardware device 24 may be tethered to a smartphone or other mobile device 12 or may be interfaced with mobile device 12 wirelessly, such as through Wi-Fi or Bluetooth. In some embodiments, mobile device 12 may be configured with an installed application so that it may receive vehicle condition data from onboard hardware device 24, provide selective access to one or more functions of mobile device 12, correlate the vehicle condition data to data for use of the mobile device 12 in various functions, and/or perform other tasks associated with the methods herein. For example, the mobile device 12 may further be configured to perform one or more functions related to an accumulation of redeemable points, such as with or without transmission of usage or vehicle condition data to one or more remote computers 16, 20.

System 10 may be equipped to correlate use of different functions of mobile device 12 with vehicle condition data. In various embodiments herein and/or in some situations, correlation may be executed using one or more of mobile device 12, one or more remote computers 16, 20 or a combination of both. For example, in some embodiments, usage data for mobile device 12 (e.g., placement of calls and/or texts or use of some navigational aids or other functions) may be correlated with vehicle speed data and/or other data using mobile device 12 with an installed application. Thus, in some embodiments, correlation of data for usage of mobile device 12 and vehicle condition data may be accomplished internally within mobile device 12. However, in some embodiments, correlation of data may be executed externally from mobile device 12, such as by time stamping usage and vehicle condition data from different devices and sending data streams to one or more remote computers 16, 20 programmed to correlate the data sets and/or to initiate or verify rewards accumulation. Alternatively, in some embodiments, an application may sometimes be internally or remotely triggered to send one or more of vehicle condition data, mobile device 12 function use data, points accumulation data, and/or any combinations thereof to one or more remote computers 16, 20.

In some embodiments, driving at such times when a vehicle is above a threshold speed (and/or when a vehicle meets other conditions) and a user refrains from use or an unapproved use of mobile device 12, a user may be credited with redeemable points at a certain rate. Alternatively, in some embodiments, driving at such times when a vehicle is above a threshold speed (and/or when a vehicle meets other conditions) and a user engages in use or an approved use of mobile device 12, redeemable points may be removed from a user account. In some embodiments, driving at such times when a vehicle is above a threshold speed (and/or when a vehicle meets other conditions) and a user engages in a use or unapproved use of mobile device 12, a user may be provided a warning message. Alternatively, other actions may be initiated if a user engages in a use or unapproved use of mobile device 12, such as removal of points, blocking a use of the device 12, or both.

In some embodiments, one or more of onboard hardware device 24 and mobile device 12 may include one or more accelerometers, gyroscopes, position sensors, and/or other sensors. For example, one or more of onboard hardware device 24 and mobile device 12 may be configured to collect position data or position data and one or more of acceleration data, orientation data, and or/other sensor data. In some embodiments, at least two 2-axis accelerometers or at least one 3-axis (or more than three axes) accelerometer may be included in one or more of onboard hardware device 24 and mobile device 12. By way of nonlimiting example, one or more of onboard hardware device 24 and mobile device 12 may include one or more of a 3-axis Bosch BMA 280 accelerometer, InvenSense MPU-6500 accelerometer or another suitable accelerometer. For example, an accelerometer may be equipped to measure G forces over a suitable range such as +/−2G and with suitable sensitivity to reliably track changes in acceleration, such as a sensitivity of greater than about 2000 LSB/G. Where an onboard hardware device 24 may also be configured for detection of vehicle crash or other emergency conditions, one or more accelerometer may sometimes be configured to detect a greater range of G forces, such as about +/−15 G.

Position and/or orientation sensors may be configured to measure changes and/or an absolute position or orientation of a mobile device 12 or onboard hardware device 24. For example, elements suitable both to measure changes in orientation and or the absolute orientation (e.g., yaw, pitch, and/or roll) of a sensor with respect to a reference position may be included. In some embodiments, an orientation sensor may include one or more elements suitable to measure each of yaw, pitch, and roll and may comprise any number of one, two, or three axis sensor elements suitably configured. For example, a device 12, 24 may include one or more solid state microelectromechanical (MEMS) gyroscopes or other solid-state elements. MEMS gyroscopes may operate, for example, using a vibrating mechanical element to sense changes in state from a reference position as understood by those skilled in the art.

In some embodiments, system 10 may be configured to calculate a speed of a vehicle, such as an average speed over a certain time interval or a substantially instantaneous speed. For example, a device 12, 24 may be configured to determine an initial speed of a vehicle using GPS and/or acceleration data, collect further acceleration data, and correlate the data to changes in vehicle speed over time in order to track vehicle speed during a trip. In some embodiments, a frequency or rate of GPS and/or accelerometer use may be based on a selected protocol for measurement of vehicle condition data. For example, some protocols may initiate GPS and/or other location service for a device more often than other protocols. In some embodiments, a device 12, 24 may include onboard GPS location capability or may be configured for network triangulation, such as may be used to locate the device position and/or an associated vehicle's position. Position data may be combined with other data (e.g., acceleration and/or orientation data) to determine a speed or track changes in speed of a vehicle or one or more other conditions of a vehicle during motion. In some embodiments, position data may be used to help verify that speed or velocity data is specifically associated with a trip. For example, in some embodiments, local movement in a confined area, even if achieving a threshold speed or threshold velocity, may not be deemed to indicate a vehicle trip. For example, for data to be deemed to be indicative of a vehicle trip, one or more devices 12, 24 may detect a threshold speed and a threshold displacement over time, such as a threshold displacement greater than about 0.1 miles, about 0.5 miles, or some other suitable threshold displacement.

In some embodiments, power consumption may be minimized in one or more of the devices 12, 24 by controlling and/or adjusting a frequency, rate, or protocol for measurement of vehicle conditions. For example, in some embodiments, an installed application may periodically initiate sampling of sensor data and/or collection of vehicle condition data. For example, a device 12, 24 may determine a speed (or change in speed over a threshold displacement) about every 10 seconds to about every 120 seconds. In some embodiments, an installed application may sample one or more sensor signals or collect vehicle condition data when initiated by one or more user actions, such as placement of a call, placement of a text, receiving of an incoming call, allocation of rewards points, or other activities.

In some embodiments, a protocol for determining a speed (or change in speed over a threshold displacement) may be adjusted or selected based on one or more factors including, by way of nonlimiting example, a battery level of a device, whether a device is charging, a duration of a suspected vehicle trip, whether a device is in an active or inactive “sleep” mode, other factors, and any combinations thereof. For example, in some embodiments, a device may sample vehicle condition data about every 10 second to about every 120 seconds over an initial time interval. If some number of consecutive or nearby sampled points indicate that a vehicle is involved in a trip, a sampling rate may be decreased. Accordingly, during some long duration trips, an application may adjust a frequency rate of sampling so that points may be accumulated under a decreased power consumption mode. For example, if over an about 10-minute period all or some threshold number of sampled vehicle condition data indicate significant movement of a device, an application may determine that a user is traveling in an extended trip, and a rate of sampling may be adjusted. In some embodiments, a device may be sampling vehicle condition data at some rate, but if some number of consecutive or nearby sampled points indicate that a user is not moving (e.g., as may be the case if the user is not travelling in a vehicle), an application may enter a sleep mode. For example, if over a 5-minute sampling period vehicle condition data does not indicate significant movement of a device, an application may enter a sleep mode. In some embodiments, a sleep mode may be a state wherein the device must be actively turned back on. Alternatively, a sleep mode may sample sensor data (e.g., examining data for signs of vehicle motion) at a low rate, such as about every 1 minute to about every 5 minutes, or at some other suitable or user defined rate. And, if the device detects data indicating significant movement or other vehicle condition data is detected, the device may automatically exit the sleep mode.

Accordingly, some applications herein may operate with reduced power consumption, including when a vehicle is suspected to be engaged in a trip or trip of threshold duration and/or when the application is running, but a user is not suspected of being engaged in a trip within a vehicle.

In some embodiments, a system 10 may be configured to periodically sample a vehicle speed and/or speed and threshold displacement. For example, a mobile device 12 processor may examine speed and/or displacement over one or more duration periods. If the processor determines that a trip has started, a start time for the trip may be logged. The processor may periodically sample sensor data to determine if the trip is still in progress. The processor may further determine a completion time for a trip. For example, if some number of consecutive or nearby samplings of a sensor signal indicate that sensor movement is not significant, a stop time for a trip may be logged. Notably, in such a scenario rewards points may appropriately accumulate when a user practices safe driving practices in stop and go traffic. Accordingly, some users, such as some users who might otherwise be frustrated by lack of points accumulation during regular trips in traffic, may be encouraged to keep using the application thereby reinforcing safe driving habits

In some embodiments, speed and/or other vehicle condition data may be determined using onboard hardware device 24 or collected directly from a vehicles OBD. Onboard hardware device 24 may then communicate speed data to mobile device 12, which may then directly correlate vehicle condition data with usage data. Alternatively, in some embodiments, time stamped speed data (or other vehicle condition data) and usage data may be independently sent to one or more external computers 16, 20 where the data may be correlated, and rewards accumulation may then be determined. Thus, at least in some embodiments, rewards data may be determined by one or more external computers 16, 20 and then sent to a mobile device 12 of a user. Accordingly, users with some mobile phones that may not have sufficient capabilities to accurately track vehicle speed may still participate in a rewards program.

In some embodiments, system 10 may be configured to calculate the speed of a vehicle and one or more additional conditions of a vehicle during motion. For example, a system 10 may be configured to determine a speed and/or acceleration of a vehicle while turning. For example, one or more gyroscopes, compasses, or other sensors suitable for providing orientation data may be included in one or more of onboard hardware device 24 and mobile device 12. Or, such data may be made available to system 10 through a vehicles OBD. Orientation data and/or rates of change therein may be combined with acceleration data in order to determine one or more conditions of a vehicle during a turning motion. For example, a radial acceleration may be estimated during a turn such as may be used to detect safe or erratic driving behavior. And, in some embodiments, a rewards system may penalize a user when erratic or unsafe diving behavior is detected. For example, in addition to erratic turning a user may be penalized for going over a certain unsafe speed, for maintaining an unsafe speed over some time period, or when traveling in certain locations.

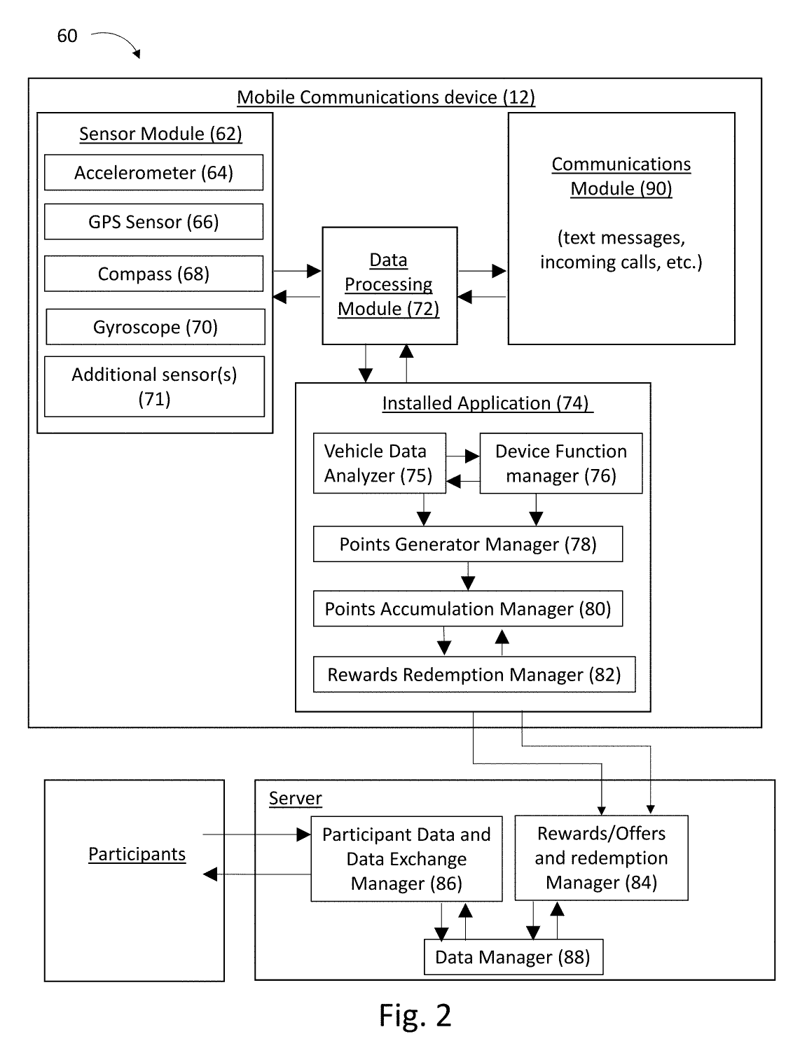

FIG. 2 shows another embodiment of a system 60 for providing a service for reinforcing and rewarding safe driving practices. As shown therein, system 60 may include a sensor module 62. Generally, sensor module 62 may, for example, comprise sensors included on one or more mobile of communications device 12, an onboard hardware device 24, other device(s), and combinations thereof. For example, in some embodiments, one or more sensors among sensor module 62 may be provided as a plug-in sensor unit that may be directly attached to mobile device 12. However, as specifically shown in FIG. 2, sensors may be included in an appropriate mobile communications device 12, such as an iPhone configured with one or more suitable accelerometer 64, GPS sensor 66, compass 68, gyroscope 70, additional sensor(s) 71, and combinations thereof. Data from sensor module 62 may be provided to data processing module 72 of mobile device 12 directly or using one or more appropriate interfaces. For example, as described above, sensors that may be part of onboard hardware device 24 may send data to device 12 via one or more cellular or wireless transceivers. Or, a plug-in sensor unit may be interfaced via a direct connection or cable, for example. And, in some cases, a suitable application or application part may be installed on an onboard hardware device 24 or other sensor unit external from mobile communications device 12, such as to facilitate collection of sensor data produced therefrom.

System 60 may further include a communications module 90, the communications module 90 may include one or more processors and/or units of memory configured for executing and storing communications data, such as logs of text messages, incoming calls, outgoing calls, and other data. Data processing module 72 may, for example, include one or more discrete and/or distributed parts of one or more processors included in mobile communications device 12. Data processing module 72 may be accessed or used for executing one or more instructions initiated by a computer program or application. For example, data processing module 72 may be accessed by installed application 74 or application parts therein (e.g., analyzer 75 or managers 76, 78, 80, and 82) as necessary for execution of one or more application instructions.

Installed application 74, which may, for example, be embodied in software, hardware, or firmware, may include one or more application parts for performing various application functions. By way of example, as an alternative to a software application, application 74 may be embodied as a non-transitory computer medium storing instructions for executing the application 74. In some embodiments, a non-transitory computer medium storing instructions for executing the application 74 may include a plug-in device configured to access data from a mobile communications device 12 via an access port. Or, a computer medium storing the application 74 may access data from a mobile communications device 12 in some other suitable way. In some embodiments, installed application 74 may include instructions for accessing and processing data within mobile communications device 12, such as by accessing one or more sensor data stream originating from one or more sensors 64, 66, 68, 70, and 71 included among sensor module 62 or sampling processed data derived from the one or more sensor data streams.

Installed application 74 may include various application parts including a vehicle data analyzer 75 and a device function manager 76. Vehicle data analyzer 75 may, for example, be configured to access vehicle condition data or sensor data from sensors module 62. Vehicle data analyzer 75 may further be configured to instruct data processing module 72 to compare vehicle condition data to one or more thresholds and/or to perform other analyses. For example, vehicle data analyzer 75 may be configured to instruct data processing module 72 to execute various functions including, for example, setting one or more rates at which sensor data is accessed and/or collected. For example, in some embodiments, a vehicle data analyzer 75 may control or adjust application of GPS and/or other location services which may be controlled via installed application 74, such as may be used to control power consumption when executing the application 74. In some embodiments, such as where installed application is embodied in hardware, vehicle data analyzer 75 may access vehicle condition data and compare the data to one or more thresholds, with or without data processing module 72, for example.

Device function manager 76 may, for example, be configured to collect data for use of different mobile device functions. For example, device function manager 76 may include instructions for accessing data logged within or by communications module 90. In some embodiments, data may be exchanged between vehicle data analyzer 75 and the device function manager 76, such as when executing one or more device warning or locking functions. Installed application 74 may further include a points generation manager 78, points accumulation manager 80, and rewards redemption manager 82. The managers (78, 80, 82) may generally be tasked with managing accumulated points via point generation and rewards redemption.

A user with a mobile communications device 12 with an installed application may further interact with one or more of the external computers 16, 20 and with database 18. For example, a rewards/offers and redemption manager 84 may be tasked with providing supplier offers to a user and managing points debits and/or credits. A data manager 88 may further be associated with database 18. A participant data and data exchange manager 86 may be tasked with receiving rewards offers from participating suppliers and exchanging information with participants in the rewards program, such as participating restaurants, merchants and other service providers.

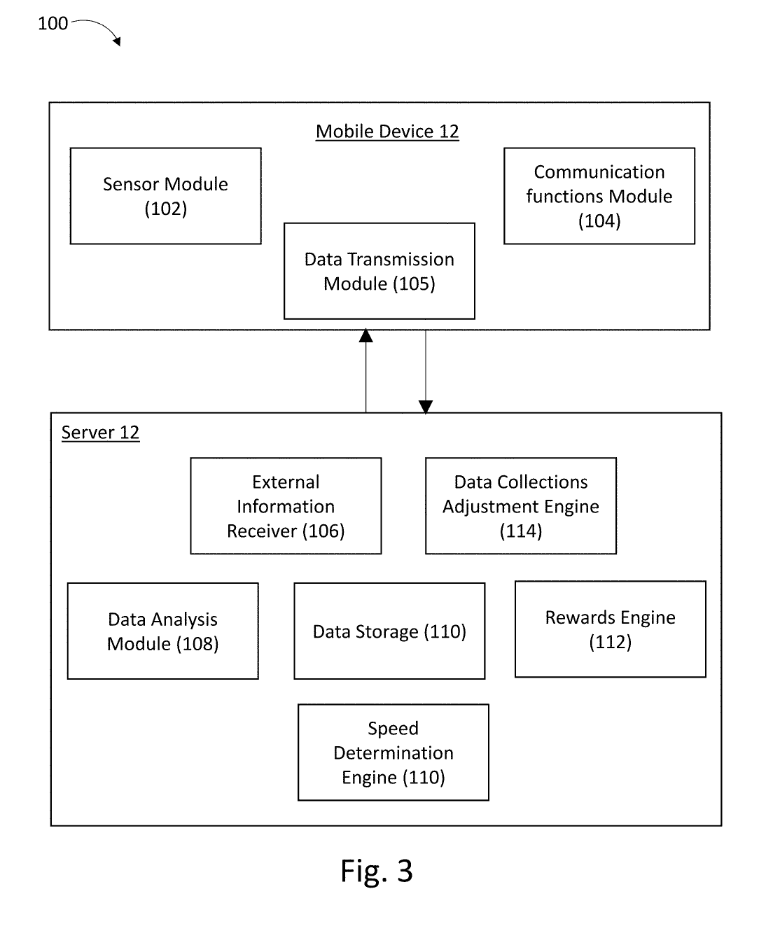

Additional aspects of systems herein may further be understood in relation to the system 100, shown in FIG. 3. As shown therein, system 100 may include a mobile device 12 including a sensor module 102, a communications functions module 104, and a data transmission module 105. Notably, in the embodiment of system 100, one or more functions otherwise executed within mobile device 12, for example, may be executed via an external computer 16, 20. For example, external computers 16, 20 may include a data analysis module 108 and a speed determination engine 110. The elements 108, 110 may, for example, be tasked with processing user device use logs and sensor data in order to determine driving habits of users. For example, periodically or at some rate, such as may be modified via data collections adjustment engine 114 and controlled via external receiver 106, external computers 16, 20 may receive data from mobile device 12. The engines 108, 110 may further interact with rewards engine 112 to distribute accumulated points and to track reward debits and or credits.

In some embodiments, system 10 may integrate data and services from one or more third-party platforms, such as social networks, cloud-based storage platforms, online content-creation and/or content delivery platforms, and advertisers. The system 10 may be administered or accessed through one or more external computers 20. In some embodiments, reward providers may, as discussed below, access the system through a computer 20 in order to interact with a rewards program of the system.

As described above, in some embodiments, system 10 may provide a client software application that a user may download and install on one or more of onboard hardware device 24 and mobile device 12, such as an Apple IPHONE® mobile communication device. The application may, for example, allow a user to establish a user account by providing identifying information, such as an email address and password. In some embodiments, the application may allow a user to establish a user account using information from a social media account. In such embodiments, for example, the service may allow a user to establish, and thereafter access, a user account by linking to, for example, a FACEBOOK® or TWITTER® social media account, or other social media platform. The service may allow the user to provide the user's name, address, age, location, relational status, advertising preferences, photographs, and other user-related information. User account information may be stored and organized in a database 18.

In some embodiments and/or under some conditions, an application may restrict a user from accessing certain functions and applications of mobile device 12 while the application may be concurrently running in the background or foreground. This preclusion from accessing applications and features of the device may effectively lock the device or place the device in a locked mode. The locked mode may substantially prevent use of certain functions that, if used by a driver while operating a vehicle, could create unsafe driving conditions and practices. For example, in some embodiments, functions of mobile device 12 that require manual manipulation by a user during function activation, operation, or both may be become locked when the application is running or when the application is both running, and one or more vehicle conditions is detected. Notably, functions that may be initiated and/or that may execute in operation without requiring manual manipulation by a user may not interfere with point accumulation. Thus, the application may be organized to recognize safe and unsafe driving practices. Unsafe practices and conditions may include but not be limited to driving or engaging in unsafe driving practices while utilizing one or more manually activated or manually executed mobile device 12 functions such as text messaging service, email communication, voice calls, gaming applications, some navigation aids or other features of a mobile device that may be external to the application, and any combinations thereof. Should a user attempt to access or utilize features and applications on a device locked by the application, the application may display an alert, message, or screen with a warning, logo, or safety reminder. In some embodiments, such an alert may be personalized, such as by reinforcing an alert or message with an uploaded photo or personalized message. This method of conditional locking of a device may be implemented to promote safe driving habits in motorists.

In some embodiments, a locked condition may prevent a user from using a mobile device feature or function. In other embodiments, a locked condition may require the user to affirmatively override application or device controls in order to use restricted functions. In further embodiments, a locked condition may provide a warning to a user when the user attempts to use a restricted function or after a user has finished using the restricted function. For example, in some embodiments, a device function manager 76 may designate whether a certain function may be prevented from use, used once affirmatively overridden, and/or a form or ordering of a warning to a user that use of the function may constitute an unsafe driving action.

In some embodiments, a predetermined threshold speed for locking the device may be set at about 5 MPH to about 25 MPH, such as about 15 MPH. In some embodiments, other thresholds may be set by the driver, or by a third party, such as by a sponsoring insurance company. And, in some embodiments, such thresholds may be location dependent or depend on whether a vehicle is driving in a certain locality, such as on either of a road or a highway. In some embodiments, a locking speed may be set at approximately zero, so as to allow use only during vehicle stops. As described above, systems herein may utilize technologies in one or more devices 12, 24 to determine a user's rate of travel. Such technologies may include onboard GPS location data, onboard accelerometers, wireless network triangulation, or other location data streams available to the device. Combining location data with time data from a device's 12, 24 internal clock may allow an application to determine a user's location, rate of travel, or both. In some embodiments, an installed application may also utilize speed data available on the device that may originate from other applications, programs, and onboard hardware. For example, in some embodiments, onboard hardware device 24 may access a vehicles OBD or the onboard hardware device 24 may be configured to independently process sensor data (e.g., accelerometer, GPS, gyroscopes, or other sensors) to independently determine and report vehicle condition data to other components of a system 10.

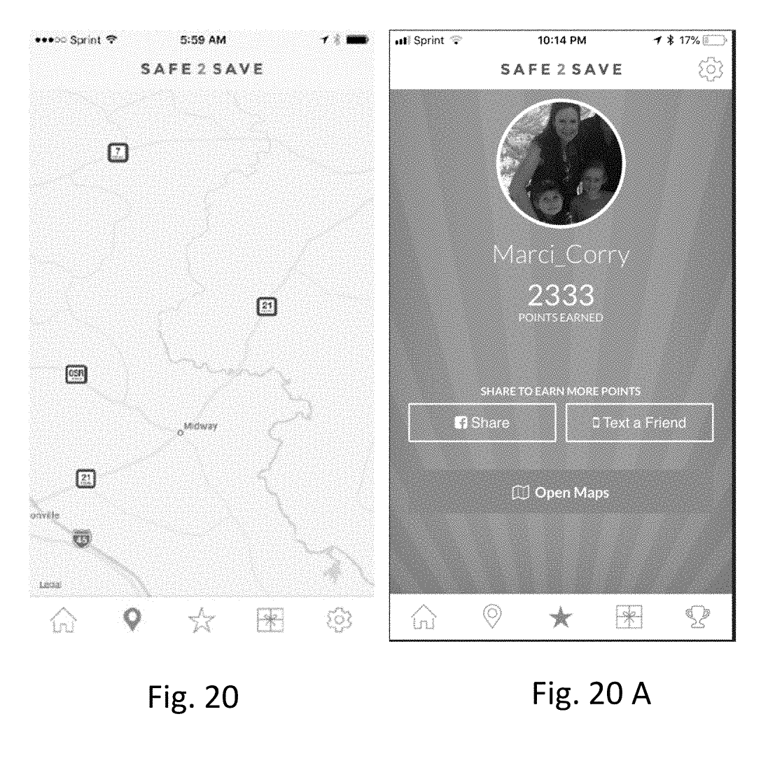

In some embodiments, if system 10 determines that a user may be traveling in a vehicle or traveling at a speed at or above a threshold speed and the user also refrains from using or attempting to use certain features of the device, such as text messaging, voice calls, email communication, or some navigational aids, a user may accumulate points or credits as may be managed through an application active on the device. In some embodiments, a user may accumulate points if the application is active and one or more vehicle conditions is met. However, if a user is traveling in a vehicle or traveling at a speed at or above a threshold speed and the user also engages certain features of the device, one or more features of the device may be blocked, or the user may be warned of an unsafe driving action to help condition the driver not to perform the activity. In some embodiments, an application may allow a user to use one or more device functions including, for example, music, navigational maps and calls using a hands-free technology such as Bluetooth. Advantageously, some applications, such as some navigational maps may be used or accessed directly using a system 10, 60, 100. For example, as shown in FIGS. 20 and 20A a “Map” screen may support operation of one or more navigation features.

In some embodiments, a user may be credited with redeemable points at a predetermined rate of accumulation. In some embodiments, a rate of accumulation may be increased if a user has exceeded a threshold amount of time without using or attempting to use mobile device 12. For example, a rate of point accumulation may be set at 2 points for every minute of travel without detection of an unsafe vehicle condition and/or without interruption of an application lock feature. Accordingly, a user may be encouraged to adopt safe driving habits. When coupled with the locking feature, the reward points system may serve as a particularly strong reinforcement tool to promote safer motor vehicle operation.

In some embodiments, restaurants and other businesses may participate in the system by providing “rewards” for which users may be able to redeem their points. These rewards may be able to be changed. For example, business owners may have access, such as in real-time, to modify which rewards are offered or may put a limit on the quantity of rewards offered in a particular time frame. For example, a business may offer a set quantity of a particular reward to be offered through an application for a particular month. Alternately, a business may put a limit on the quantity of rewards an individual user may redeem in a particular time frame. For example, a business may limit a user to a single coupon or other offer per day or set a limit for the number of rewards a user may redeem in a month, or other suitable time period.

In some embodiments, a system may provide access to reward providers through a web portal linked to an installed application. By triangulating geo-location or other means of identification, the system may be able to track what deals were redeemed at a location and send monthly reports to businesses. Accordingly, businesses may be able to track participation and success of particular rewards or success of particular rewards with one or more user demographics.

In some embodiments, a rewards provider may set a rate at which points may be accumulated, or otherwise assign a point value for rewards. In other embodiments, the provider may suggest a value, and the system may assign a point value to the reward based on similar rewards.

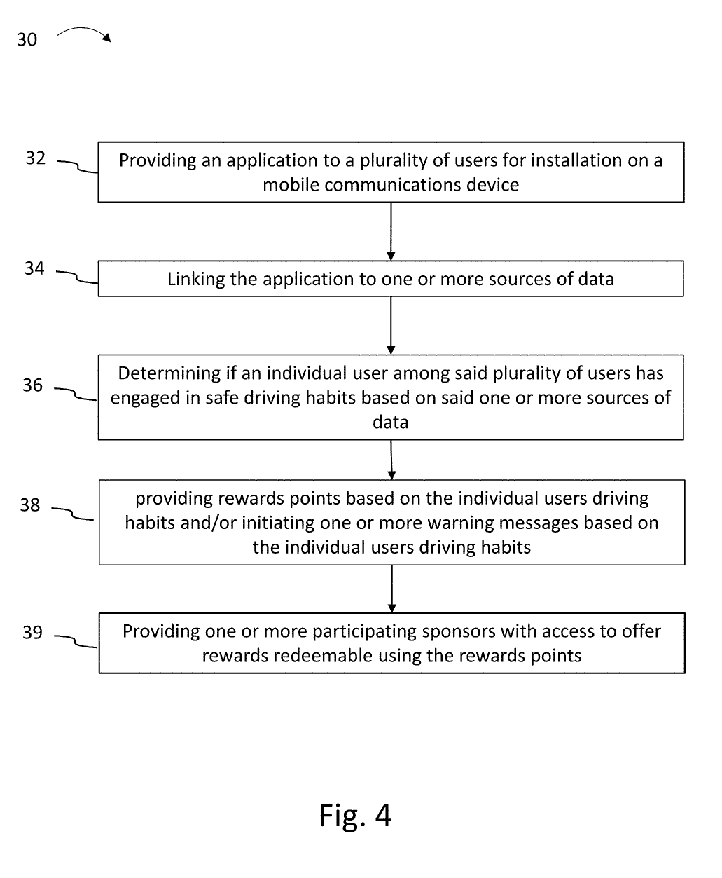

FIG. 4 shows a flowchart of a method 30 for administering a rewards redemption program for encouraging safe driving habits. As shown in step 32, the method 30 may include providing an application to a plurality of users for installation or use with a mobile communications device 12. In some embodiments, one or more parts of said application may also be installed on one or more of an onboard vehicle hardware device 24 or external sensor unit. An application may, for example, be provided as hardware, software, firmware, or any combinations thereof.

As shown in step 34, the application may be linked to one or more sources of data. For example, an application may be configured for accessing one or more sources of data, including, for example, data from a communications module 90 and a sensor module 62. As shown in step 36, the method 30 may include determining if an individual user among said plurality of users has engaged in safe driving habits based on said one or more sources of data. For example, determining if an individual user has engaged in safe driving habits may include correlating user engagement of one or more functions of mobile communications device 12 with one or more driving operation. For example, in some embodiments, a user may be deemed to have engaged a function of mobile communications device 12 if they activate a function, attempt to activate a function, or otherwise interact with an executing function of communications device 12.

In some embodiments, such as in a part or sub step of step 36, method 10 may include designating one or more functions of the device 12 as a member of one or more groups of functions. For example, a function of device 12 may be designated as a member of a first group of functions that may require manual manipulation by a user during function activation, execution, or both. Or, a function of device 12 may be designated as a member of a second group of functions that may not require manual manipulation by a user during function activation, execution, or both. In some embodiments, designating a function as a member of a group of functions may include storing one or more lists of functions using device function manager 76. When a function is engaged by a user, an application may scan one or more function lists in order to identify if the engaged function is a member of one or more functions lists, such as may identify a function as a function that may be safely executed while driving or not. Alternatively, a device function may be configured to automatically activate one or more hands-free enabling technologies when the device function is engaged. And, in some embodiments, an application may instruct communications device 12 to communicate activation of a hands-free enabling technology such that a device function is automatically designated as an allowed function within the application. For example, in some embodiments, functions may be designated as members of a group of functions that may be executed using Bluetooth or using another hands-free enabling technology. In some embodiments, method 10 may include providing access to one or more groups of functions using an installed application. For example, a user may be able to access one or more navigation applications using an installed application.

Still referring to step 36, in some embodiments, based on data accessed from communication module 90 and from sensor module 62, the method 30 may determine if a user has engaged a device function that requires manual manipulation by a user during function activation, operation, or both while executing one or more driving operation. By way of nonlimiting example, a driving operation may include driving a vehicle or driving a vehicle over a threshold speed or velocity. And, if the use has engaged such a function while executing one or more driving operations, the user may be deemed to have engaged in an unsafe driving practice.

As shown in step 38, the method 40 may include providing rewards points based on an individual's driving habits. Or, one or more warning or blocking functions may be initiated based on an individual's driving habits. As shown in the step 39, the method 30 may include providing one or more participating sponsors with access to offer rewards redeemable using the rewards points.

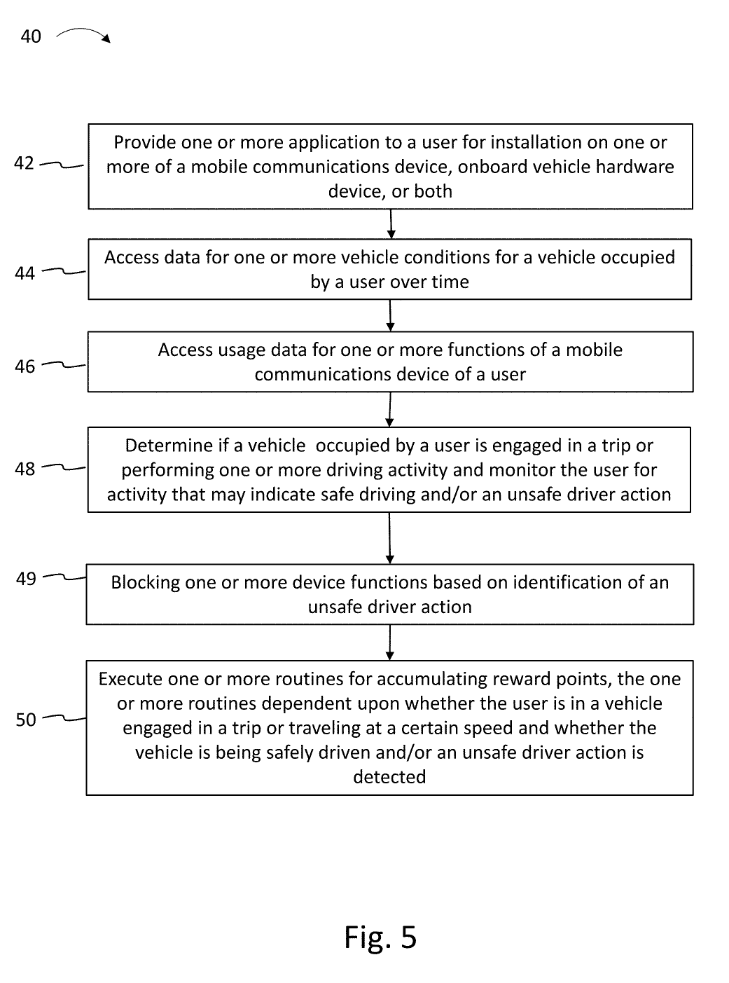

FIG. 5 is a flowchart of a method 40 for encouraging safe driving habits in a user. As shown in step 42, the method 40 may include providing an application to a user for installation on a mobile communications device 12, or on a mobile communications device 12 and one or more additional device such as an onboard vehicle hardware device 24 or plug-in sensor unit. In some embodiments, an application may include one or more application parts and the one or more parts of the application may be installed as necessary for execution of a given function of a rewards system. For example, separate parts of an application may be individually installed on each of a mobile communications device 12 and an onboard vehicle hardware device 24, depending, for example, on whether one or more of the devices 12, 24 are tasked with collecting data associated with a vehicle condition.

As shown in a step 44, data associated with one or more vehicle conditions may be accessed for a vehicle occupied by the user over time. Data may, for example, be accessed for processing based on one or more requests for the data as may be provided by an installed application. In some embodiments, vehicle condition data may be accessed and stored in one or more units of memory so that it may be further processed using the installed application. In some embodiments, vehicle condition data may be accessed from one or more of a vehicles OBD, mobile device 12, onboard vehicle hardware device 24, and any combinations thereof. Vehicle condition data may include one or more of a speed of a vehicle, an acceleration or deceleration of a vehicle, a radial acceleration of a vehicle, or any combinations thereof. In some embodiments, sensor data may be accessed and used to calculate one or more conditions of a vehicle. For example, in some embodiments, one or more of GPS sensor data, accelerometer sensor data, or both may be accessed and processed to determine vehicle condition data. In some of those embodiments, data from one or more other sensors, such as orientation data, may also be collected and processed. One or more vehicle conditions may then be determined. For example, one or more of a speed, acceleration, radial acceleration or other vehicle condition be calculated from the collected sensor data.

In step 46, data for engagement of one or more functions of a mobile communications device may be accessed. For example, one or more data use logs for a given function of a mobile communications device may be accessed so that it may be further processed using an installed application. Or, usage data may be accessed selectively, such as when one or more functions of the device are engaged. For example, if a user sends a text message, a message indicating use of the text message function of the communications device 12 may be automatically identified. Thus, for example, the method 40 may periodically obtain a log indicating engagement of a given function. Or, data indicating use of a given function may be selectively accessed whenever a user engages a function.

As shown in step 48, the method 40 may include determining if a vehicle occupied by a user is engaged in a trip or performing one or more driving activity. For example, the method 40 may determine if a vehicle is traveling above a threshold speed or threshold velocity or traveling above a threshold speed or threshold velocity and over a threshold level of displacement. Further in step 48, a processor may monitor a user for activity that may indicate safe driver activity and/or if an unsafe driver action is detected. For example, a processor may determine if a vehicle is traveling above some threshold speed, such as about 15 MPH or some other suitable speed. To determine if a user is in a vehicle and engaged in a trip, a processor may periodically analyze accessed speed and or acceleration data over some time interval and determine if the speed and/or acceleration data may be associated with a trip. For example, a processor may consider that sometimes during a trip a vehicle may be stopped or slowly moving. However, if the vehicle is periodically accelerating and/or decelerating over some reasonable interval of time, the processor may still determine that the user is moving or traveling in some direction, such as along some general displacement vector. In some embodiments, a processor may determine that a user is engaged in a trip of certain duration, such as a long duration. And, in some embodiments, a processor may adjust a rate at which it checks to determine if a vehicle may still be moving or traveling along some general direction. For example, if a user is engaged in a trip of duration lasting about 10 minutes, about 20 minutes, or about 1 hour, an application may direct a processor to adjust a rate at which speed and/or other vehicle condition data is accessed. Accordingly, in some embodiments, an application for collecting points and/or warning a driver may execute (e.g., in a background or foreground process) while minimizing a power consumption.

In a step 50, the method 40 may include executing one or more routines for accumulating reward points, the one or more routines dependent upon whether the user is in a vehicle engaged in a trip or traveling at a certain speed and whether the vehicle is being safely driven and/or an unsafe driver action is detected.

Additional information related to embodiments of the methods and systems described herein may further be understood in terms of the exemplary description and screen shots provided below.

In some embodiments, an installed application may provide a “Home Screen” with tabs for accessing various features of the application. These tabs may, for example, be represented as icons at the bottom of the screen and interaction with the icons may open an associated screen of the application. Each tab may, for example, be related to a feature or function of the application. For example, an application may include tabs such a Home tab, a Map tab, a Points tab, a Rewards tab, and a Settings or Utilities tab, other tabs, and any combinations thereof.

The “Home” screen may display the picture of a loved one and serve as the main screen displayed during locked mode of the application. Display of a loved one may help encourage a mobile device user to consider the risks to their loved ones while engaging in in risky mobile device use while driving. The “Map” screen may support one or more navigation features of the application. The “Points” screen may, for example, display a user's avatar and contain a display of the user's current reward point total. A “Rewards” screen may serve as the screen for accessing any feature and functions as to spending accumulated points and redemption of purchased rewards. A “Settings” or “Utilities” tab may, for example, facilitate any miscellaneous features and functions that do warrant a separate tab.

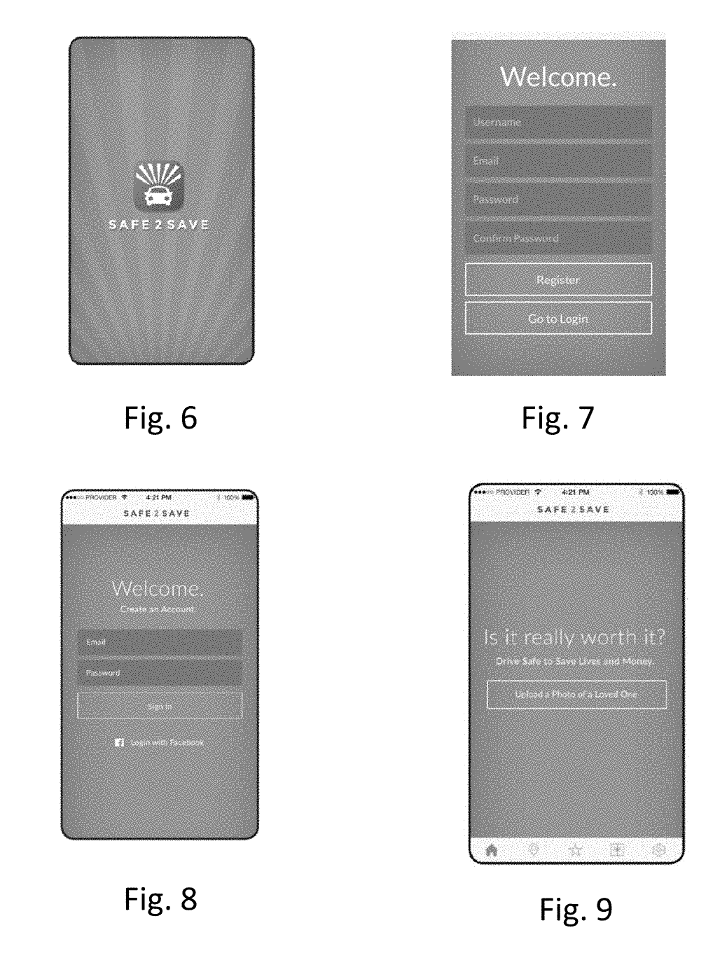

As shown in FIG. 6, an application may open to an introductory screen with corporate branding on the page. This page may automatically transition to a registration page for new users, as seen in FIG. 7. The registration page may contain data entry fields into which personal data may be entered for account creation purposes. The personal data to be entered may include, for example, “Username”, “Email”, “Password”, and “Confirm Password” fields. The registration page may contain a button labeled “Register” to execute creation of a new user's account once any appropriate data entry fields have been completed. The registration page may contain a button labeled “Login” to bring registered users to a login page, as seen in FIG. 8, that may contain data entry fields for “Username” and “Password” data that may be required to access a user's account and to initiate the application's usage. The login page may contain a button to allow login using a social media account such as Facebook, LinkedIn, or such type of site or service.

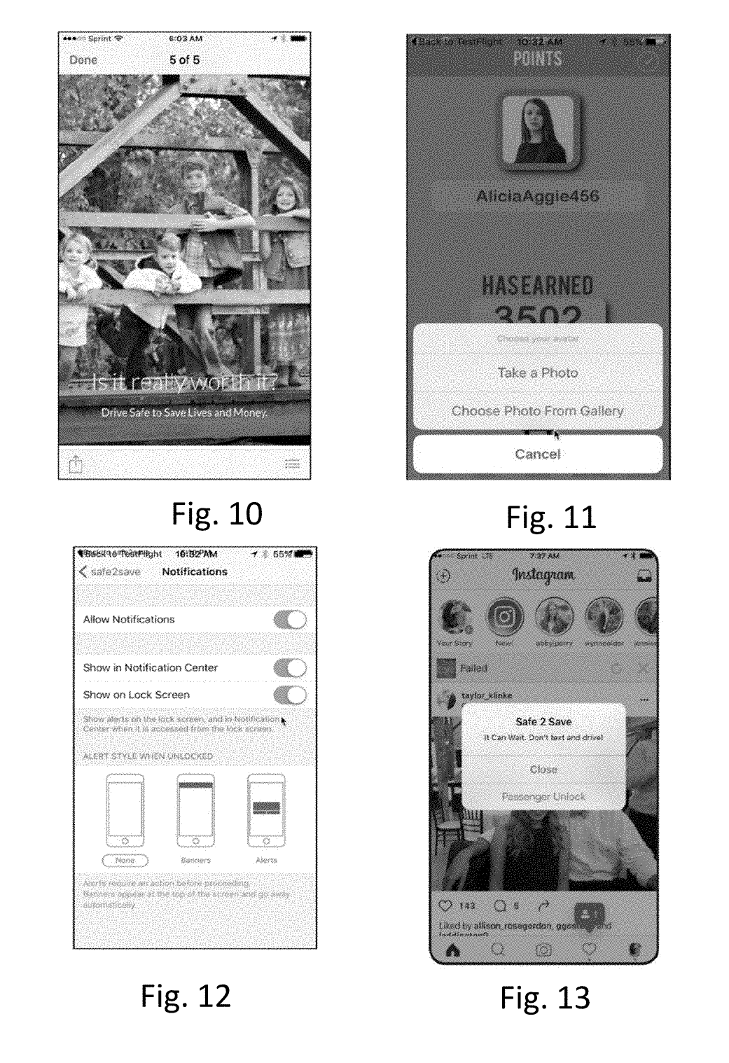

During initial account creation, the registration process may prompt the user to upload a picture of a loved one or other subject to serve as a personalized incentive to practice safe driving habits. The picture upload screen, as seen in FIG. 9, may contain messages that may induce a user to consider safe driving practices. The messaging may include statements such as, “Is It Really Worth It? Drive Safe to Save Lives and Money.” The picture upload page may include a button to proceed to the upload process. The button may be labeled “Upload a Photo of a Loved One”. The picture upload step may be optional and the application, if provided, may display the picture during the locked device mode of the application, as seen in FIG. 10. The display of a loved one's image may work in conjunction with the points system and locked mode feature to encourage safe driving practices. The upload process may accommodate a single image or a plurality of images to be accessed by the application.

The registration process may then proceed to a page, as seen in FIG. 11, to allow creation of an avatar for the user's account. The avatar creation page may allow the user to select a picture that may already exist on the device or select to take a picture using the device's camera.

As shown in FIG. 12, a device may be configured in a particular manner to utilize an application. Such configuration considerations may, for example, include turning particular settings on, off, or selecting a particular mode. For example, on an iPhone, a user may enable a Notifications feature. Other device settings on an iPhone that may be set in a particular modality may, for example, include Alerts, Location tracking, and GPS options. A user may select one of a variety of notification or warning types.

Once registration and initial setup procedures are complete, it may be possible to utilize one or more of an application's features, including, for example, device locking and point-accumulation method of promoting safe driving or other application features. In some embodiments, if a user attempts to access a locked device without engaging any sort of temporary access mode, an alert as previously disclosed may appear on the screen. An alert may comprise a box with a message such as, “It Can Wait. Don't text and drive!”, such as seen in FIG. 13. An alert may include buttons that may allow a user to select from closing the alert and from entering a temporary unlock mode. For example, in some embodiments, if a user begins texting or emailing while driving over 15 mph, then a warning will pop up. If the passenger chooses to unlock the device to use the restricted feature, then the dialog box may close for a period of time, such as 10 seconds, before popping up again. Such repeated warnings may serve to frustrate unsafe behavior. In some embodiments, during use of a restricted feature, point accumulation may be suspended. In some embodiments, such suspension may continue for a period of time after use of a restricted feature. In other embodiments, use of a restricted feature may result in point deduction.

A temporary unlock mode may be known as a Passenger Unlock mode and allow a passenger to access applications such as music and navigation functions. A Passenger Unlock feature may allow device access for a brief period, such as one to two minutes. Other embodiments may contain navigation and map features built into an installed application.

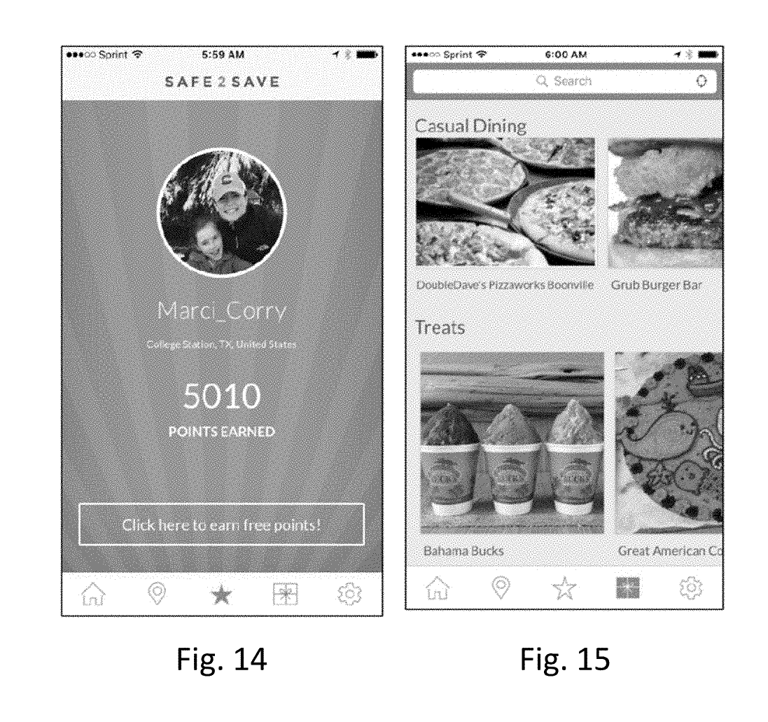

As a user accumulates points in an installed application, a total of accumulated points may be displayed during the locked mode as seen in FIG. 14. The user may spend the points to redeem rewards that may be offered by participating businesses. As seen in FIG. 15, these rewards may be accessed by the user through a particular page of the application. For the Rewards section, a business may provide pictures, a tagline, and other relevant business information such as operating hours, address, URL, and such information. An application user may then select a participating business and review the reward options offered by the business in question. In some embodiments, a user may tap on a picture to view offered rewards.

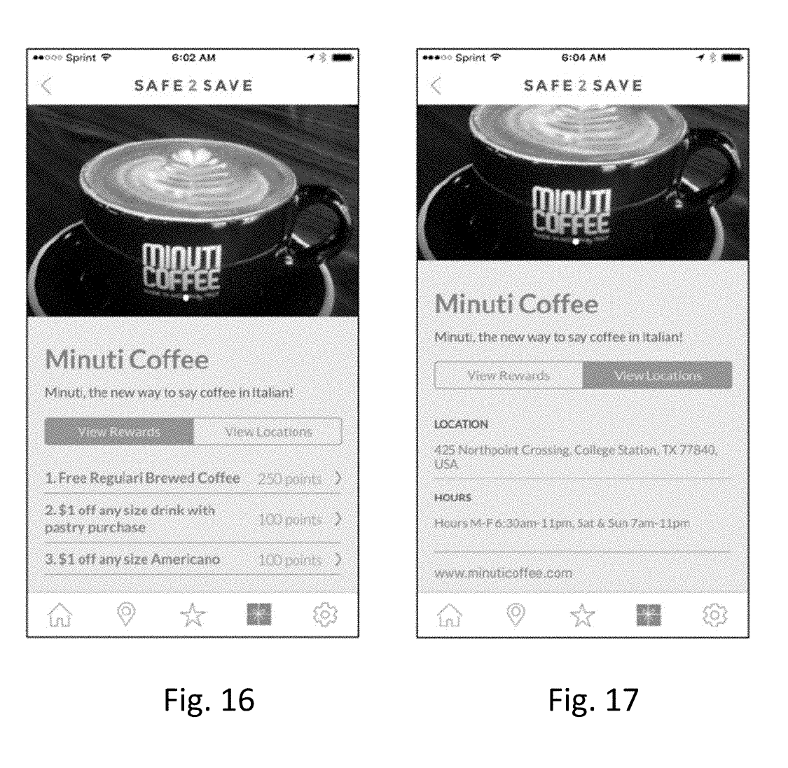

As seen in FIGS. 16 and 17, the user may then select a reward that may be offered for an amount of points equal to or less than the accumulated total of the user's account. The user may have the option to view the location of participating businesses by location. The option may be accessed via a button the Rewards screen and then displayed on an in-application map. As seen in FIG. 16, the application may then display an alert to confirm the use of the designated quantity of reward points from the user's account. The alert may require input to accept or decline the expenditure of points. This acceptance request may be in the form of “Yes” and “No” options in the alert.

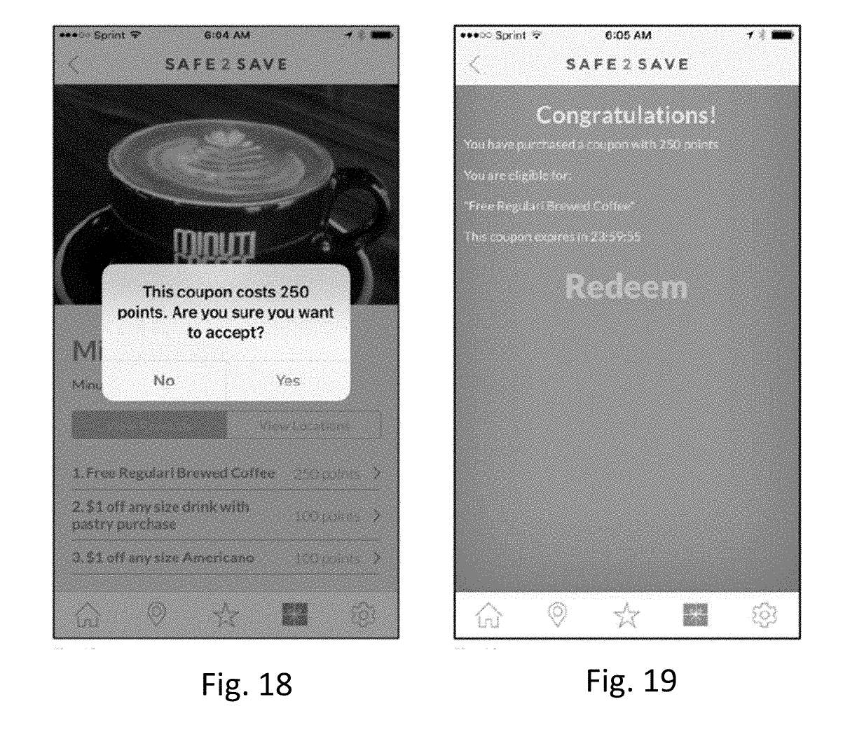

As seen in FIG. 18, confirming the point expenditure of the afore mentioned acceptance request may transition the application to a Confirmation and Redemption screen. The Confirmation and Redemption screen may display information such as the number of points spent to claim the reward, the name of the reward, and any expiration information concerning the reward. Such a screen may allow for redemption of the reward when the user is ready to collect the reward at the associated business. Accessing the reward redemption function may prompt a redemption confirmation notification. As seen in FIG. 19, such a notification may include instructions as to the process for collecting the reward at the associated business. After a reward is redeemed, used points are deducted from the user's total of points earned.

In some embodiments, an application may limit a user to no more than one reward offer to be claimed from a single business in a 24-hour period. Any attempt to redeem claims in violation of the 24-hour restriction may result in an alert appearing on the screen to inform the user that the claim is denied.

As may be seen in FIG. 20, the application may support an in-application map feature. Such a map feature may be GPS-enabled so as to act as an in-application navigation feature. Such a feature may allow the user to navigate to the business offering a purchased reward. Such a map feature may also be utilized to display the locations of all businesses offering rewards.

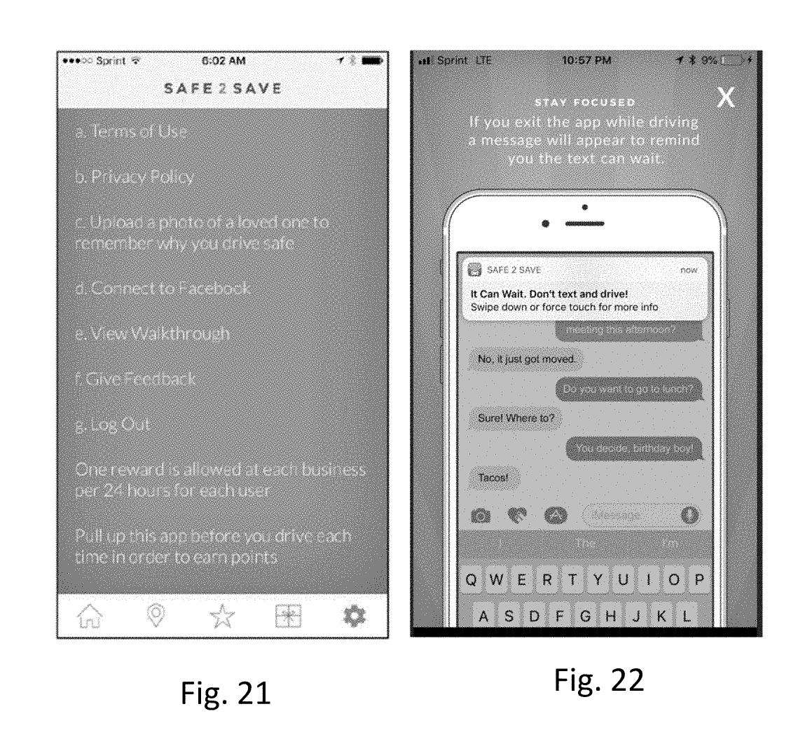

As seen in FIG. 21, other pages, screens, and tabs of the application may include sections for information such as Terms of Use, Privacy Policy, a photo upload link, a link to connect the application to a social media account, a link to a Walkthrough on how to use the application, a link to offer feedback on the application, Help/FAQ, and a Log Out function. Additionally, such a screen may include reminders related to the operation of the application. Such reminders may be the one reward per 24-hours policy and a reminder to open the application before beginning to drive so as to accumulate points.

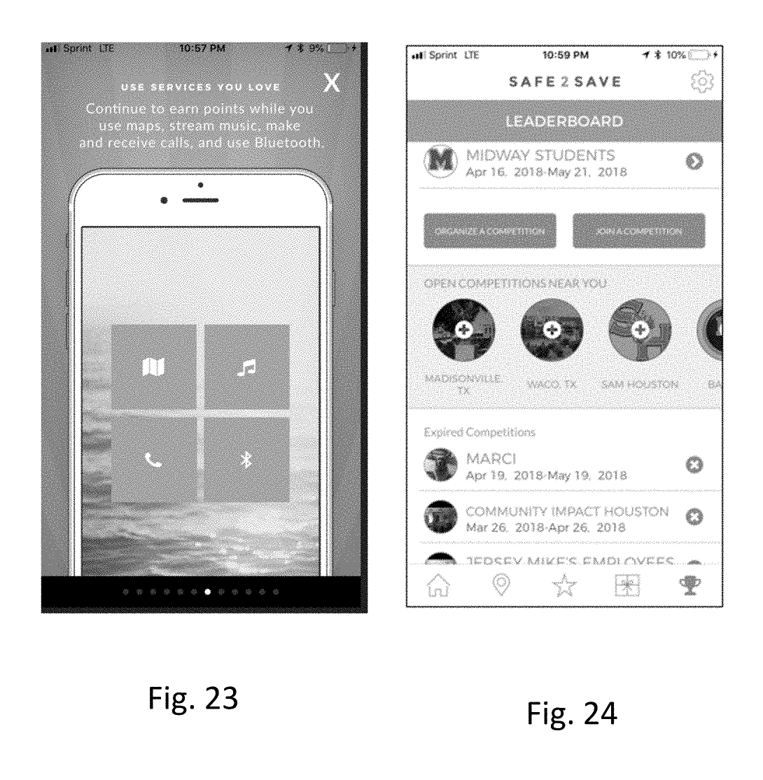

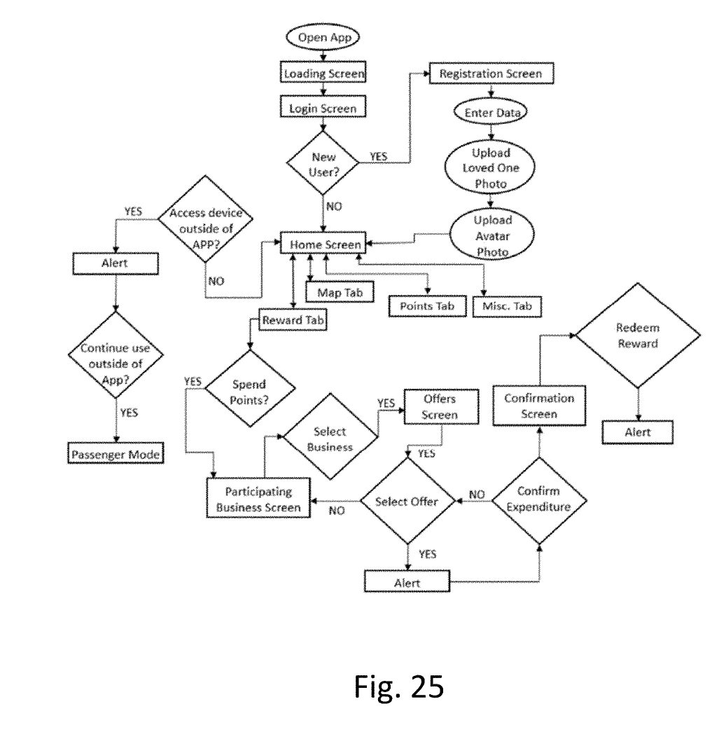

As seen in FIG. 22, a warning message may appear when exiting an application. And, in some embodiments, a warning message may appear when engaging a function or when exiting a function. As shown in FIG. 23, one or more icons may be displayed within an application. The icons may display one or more functions accessible within the application. A flow diagram of a method of rewarding safe driving using an application can be seen in FIG. 23. As may be seen in FIG. 23, a user may interact with the application in a variety of ways. In some embodiments, as shown in FIG. 24, a leader's board may also be accessible within the application. The disclosed sections are intended to communicate the nature of information that may be displayed and are not to be understood as being limited to the sections listed.

In further embodiments, the application may support a mode to allow point accumulation to continue for a user utilizing device functions through hands-free technologies. Phone calls, text messages, navigation features, and other device functions that may be utilized by vehicle on-board capabilities may not cause the user to exit the point accumulation mode. For example, if the application detects that a phone call is being routed through the hands-free technology built into the vehicle, the application may not classify such use as an unsafe practice. Another such example may be the use of in-vehicle text message systems. Such systems may verbalize an incoming text message and allow the driver to craft a verbal response that is then sent as a text message. If the application detects such a form of text messaging being utilized, the application may classify such use as a safe driving practice and may not suspend the point accumulation mode and/or perform one or more other actions described herein associated with unsafe driving practices.

The analyzers, managers, modules, applications, and application parts described in connection with the embodiments disclosed herein may be implemented in electronic hardware or as software, firmware, or combinations thereof. And, in some cases, the above components may be described in terms of one or more functions they may perform. Thus, hardware and/or software may sometimes be described based on function or application. Whether a given component or function is applied in hardware or in software or firmware may depend upon the application and/or overall system constraints. One skilled in the art may implement a function described herein as either hardware, software or firmware depending on the application and/or overall system constraints. However, such implementation should not be interpreted as departing from the scope of the present invention.

Although the disclosed subject matter and its advantages have been described in detail, it should be understood that various changes, substitutions and alterations can be made herein without departing from the invention as defined by the appended claims. Moreover, the scope of the claimed subject matter is not intended to be limited to the particular embodiments of the process, machine, manufacture, composition, or matter, means, methods and steps described in the specification. Among other things, any feature described for one embodiment may be used in any other embodiment, and methods described and shown in the figures may be combined. In addition, the order of steps shown in the figures and described above may be changed in different embodiments. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods or steps.

What is claimed is:

1-24. (canceled)

25. A method of administering a rewards program for encouraging safe driving practices, the method comprising:
providing an application to a plurality of users for installing on a mobile communications device;
linking the application to one or more sources of data, the one or more sources of data including a first source of data comprising a communications module of said mobile communications device and a second source of data comprising a sensor module;
determining whether an individual user among said plurality of users has engaged one or more user functions of said mobile communications device based on said first source of data;
determining whether said individual user has performed a driving activity based on said second source of data;
using said application to correlate if said individual user has engaged said one or more user functions of said mobile communications device while performing said driving activity in order to determine if said individual user has performed one or more unsafe driving activities;
providing redeemable rewards points to said individual user based on whether the individual uses the application while driving without performing said one or more unsafe driving activity; and
providing one or more participating sponsors with access to offer rewards redeemable using the rewards points.

26. (canceled)

27. (canceled)

28. The method of claim 25 further comprising:
blocking access to at least one function among said one or more user functions of said mobile communications device if said individual user has engaged said at least one function while performing said driving activity.

29. The method of claim 28 wherein said at least one function includes text messaging.

30. (canceled)

31. (canceled)

32. (canceled)

33. (canceled)

34. The method of claim 25 further comprising designating said one or more functions of said mobile communications device as either of a member of a first group of functions or a member of a second group of functions;
wherein said first group of functions includes functions that require manual manipulation by a user during function operation;
wherein said second group of functions includes functions that do not require manual manipulation by a user during function operation; and
wherein said determining if said individual user has engaged in said unsafe driving habits includes correlating engagement of said first group of functions with said driving activity.

35. The method of claim 34 wherein said first group of functions includes text messaging, manually engaging in an outgoing or an incoming call, or manually accessing one or more navigational aids.

36. The method of claim 34 wherein said second group of functions includes placing an outgoing call or answering an incoming call using a hands-free application, accessing a navigational function using a hands-free application, or both.

37. The method of claim 34 further comprising providing access to at least one function among said second group of functions within said application.

38-42. (canceled)

43. The method of claim 25 further comprising providing access to one or more functions that do not require manual manipulation by a user during function operation within said application.

44. The method of claim 25 further comprising providing access to a navigational aid within said application.

45. (canceled)

46. The method of claim 25 wherein said sensor module is included in an onboard hardware device, the onboard hardware device configured for connection to a vehicle using an auxiliary power socket.

47. (canceled)

48. The method of claim 25 further comprising:
providing one or more warning messages to said individual user if the individual user has performed said one or more unsafe driving activity:
wherein said one or more warning messages include one or more personalized photo, message, or both.

49. A system for discouraging unsafe driving habits while driving a vehicle, the system comprising:
a mobile communication device capable of executing one or more device functions, the device configured to receive sensor data from a sensor module, the device being configured to determine when the sensor data indicates that the device may be present in a vehicle and a user engages in one or more driving activities and said user concurrently attempts to engage at least one of said one or more device functions in order to detect one or more unsafe driving activities;
wherein said device may be configured for operation in an active state where it provides one or more warning messages in response to detection of one or more of said one or more unsafe driving activities;
wherein said device is configured to accumulate rewards points when said device is configured to operate in said active state;
a rewards server in communication with the device, the server being configured to offer rewards redeemable using said rewards points.

50. The system of claim 49 further comprising an onboard hardware device, the onboard hardware device configured for connection to a vehicle using an auxiliary power socket; and
wherein at least a portion of said sensor data is collected using said onboard hardware device.

51. The system of claim 49 further comprising an onboard hardware device, the onboard hardware device configured to access a vehicle on-board diagnostics system; and
wherein at least a portion of said sensor data is collected using said onboard hardware device.

52. The system of claim 49 wherein said sensor module includes a GPS sensor and one or more accelerometers.

53. The system of claim 49 wherein said device is further configured to modify the accumulation of said rewards points based on a user's driving habits.

54. The system of claim 49 wherein said one or more driving activities includes driving at a speed or velocity above a threshold speed or velocity.

55. The system of claim 49 wherein said one or more driving activities includes driving at a speed or velocity above a threshold speed or velocity and traveling over a threshold level of displacement.

56. The system of claim 49 wherein said device is configured to select or adjust a frequency or rate for determining when the sensor data indicates that the device may be present in a vehicle and the user engages in said one or more driving activities based on one or more of a battery level of the device, whether the device is charging, a duration of a suspected vehicle trip, or whether said device is in an active or sleep mode.

57-61. (canceled)
